(19) United States
(12) Patent Application Publication
(10) Pub. No.: US 2020/0141565 A1
(43) Pub. Date: May 7, 2020

(54) LAMP

(71) Applicant: PROSPEROUS (NINGBO) LIGHTING APPLIANCE CO., LTD., Ningbo (CN)

(72) Inventors: Zhongjie SUN, NINGBO (SG); Guangrong XU, NINGBO (CN); Xiangjun YU, NINGBO (CN); Huadong WANG, NINGBO (CN)

(21) Appl. No.: 16/447,128

(22) Filed: Jun. 20, 2019

(30) Foreign Application Priority Data
Nov. 6, 2018 (CN) 201811312543.1

(51) Int. Cl. F21V 23/06; F21V 25/00; H01R 13/44; H01R 24/28

(52) U.S. Cl. CPC F21V 23/06; F21V 25/00; H01R 2103/00; H01R 24/28; H01R 13/44

(57) ABSTRACT

The present disclosure discloses a lamp comprising a lamp body. The lamp body has a hidden connecting member on its back. The lamp body comprises connector terminals on both sides thereof. The connector terminals comprise a first connecting member and a second connecting member. The first connecting member comprises a pin, and the second connecting member comprises a plug for inserting the pin. The plug and the pin are electrically connected to the hidden connecting member of the lamp body. The pin further comprises an insulating portion. The lamp can conform to safety requirements and mitigate the risks of safety hazards.

### CROSS-REFERENCE TO RELATED APPLICATIONS

This application claims priority to Chinese Patent Application No. 201811312543. 1 with a filing date of Nov. 6, 2018. The content of the aforementioned application, including any intervening amendments thereto, is incorporated herein by reference.

### TECHNICAL FIELD

The present invention relates to the field of lighting technologies, and in particular, to a lamp.

### BACKGROUND

In a conventional lamp of the art, a connector is arranged on the back so that the lamp is powered by the wiring of the connector to operate. The disadvantage is that each lamp of the lamp should be separately powered to enable the normal operation of the lamp.

In order to simplify the wiring configuration of the lamp, a combined lamp has appeared in the market. The two ends of the combined lamp are provided with connector terminals, and the power supply is plugged through the connector terminals at one end to enable to lamp to operate. The lamps of this type can also be connected to each other, and only one of the lamps can be powered during, operation of the connected lamps. However, the lamps are connected from the connector terminals on both sides and require special matching of the wiring sleeves to operate the lamp. The matched wiring sleeves should be placed at both ends of the lamp. If the lamp is installed in the closed package, there would be a problem when connecting the lamps.

Therefore, the prior art requires that the back connector and the two side connector terminals are both incorporated and arranged on one lamp. If the back connector is used for power supply, then two connector terminals on the side will be electrified at the same time. If a pin component in one of the connector terminals is not protected, it may be touched by a finger and may cause a safety hazard. Such a configuration may not meet some safety requirements.

### SUMMARY

The technical problem to be solved by the present invention is to provide a lamp that satisfies safety requirements and mitigate risks of safety hazards.

An embodiment of the present invention involves a lamp comprising a lamp body, wherein the lamp body has a hidden connector on its back, the lamp body comprises connector terminals on both sides thereof, the connector terminals comprise a first connecting member and a second connecting member, the first connecting member comprises a pin, and the second connecting member comprises a plug for inserting the pin, the plug and the pin are electrically connected to the hidden connecting member of the lamp body, and the pin comprises an insulating portion.

In an embodiment, the top of the pin comprises a protrusion, the protrusion is integrally formed with the pin, the insulating portion is wrapped around the protrusion, a groove is provided on the circumference of the protrusion, and the outer end of the insulating portion is in alignment with the outer portion of the pin.

In an embodiment, the outer surface of the pin is covered with an insulating sleeve, a rectangular frame is arranged on one side of the first connecting member and outside the insulating sleeve, a rotatable insulating block is arranged on the insulating sleeve and the rectangular frame, an L-shaped connector is mounted on the insulating block, one end of the L-shaped connector extends through the insulating block to be in contact with the pin and the insulating sleeve, the other end of the L-shaped connector faces the first connecting member, the plug includes a conductive post electrically connected to the connector of the lamp body and an insulating head wrapped outside the conductive post, the insulating head has a groove on one side facing the second connecting member, a through hole adapted to the L-shaped connector is opened at the bottom of the groove so that the conductive post is connected to the outside, and the inside part of the groove further comprises a transmission path adapted to an adjustment mechanism.

In an embodiment, the outer surface of the first connecting member has an elastic piece, and the inner wall of the second connecting member has a block connected to the elastic piece.

In an embodiment, the top and bottom of the first connecting member respectively comprises a groove, one end of the elastic piece is fixed at the bottom of the groove, the other end of the elastic piece extends obliquely to the outside of the groove, the block has a right-angled triangular prism shape, the side of block close to the opening of the second connecting member is inclined, and the other side of the block is in a vertical state.

In an embodiment, the insulating block is movably mounted on the outer side of the insulating sleeve by bearings, a hollow cylindrical structure is arranged on a side of the insulating block away from the insulating sleeve, the rectangular frame comprises an adjusting, mechanism, the adjusting mechanism includes a rotating shaft which is disposed through the bearing on the side wall of the rectangular frame, the rotating shaft extends to the inside part of the cylindrical structure and is not in contact with the inner wall of the cylindrical structure, a gear is fixedly mounted on the rotating shaft, and the gear is located outside of the rectangular frame.

In an embodiment, the top of the rotating shaft is recessed, a lifting column is provided in the recess at the top of the rotating shaft, the lifting column is connected to the groove bottom of the recess of the rotating shaft by an elastic telescopic rod, a T-shaped groove is arranged on the lifting column, a movable driving assembly is arranged in the inside part of the T-shaped groove, and a stopper adapted to the driving assembly is disposed on the inner wall of the cylindrical structure.

In an embodiment, the driving assembly comprises a rod-shaped driving member, a connecting rod is vertically mounted on the rod-shaped driving member, the other end of the connecting rod extends below the lifting column and is fixed with a plate-shaped driving member, and the rotating shaft has a through-hole to allow the plate-shaped driving member to pass through.

In an embodiment, the rod-shaped driving member is disposed in a transverse groove in the T-shaped groove, one end of the rod-shaped driving member extends through the lifting column to the outside of the lifting column, an elastic member is disposed between the other end of the rod-shaped driving member and the T-shaped groove.

In an embodiment, the insulating block has a cylindrical shape, an outer surface of the insulating block passes through the insulating sleeve to connect to outer surface of the pin, a driven wheel is fixedly mounted at one end of the insulating block, a driving wheel rotatably engaged with the driven wheel is movably mounted inside the rectangular frame, one end of the driving wheel extends through the rectangular frame to the outside of the rectangular frame, a rubber block is fixed at the opening of the rectangular frame, a conductive rod is disposed through the rubber block, one end of the conductive rod is in contact with an outer surface of the insulating block, and the other end of the conductive rod extends to the outside of the rectangular frame Compared with the prior arts, the present invention has the following advantages: the insulating portion is arranged on the pin, so that the safety regulation is completely complied with. The finger is prevented from contacting the conductive member in the assembled state of the lamp. Especially the test needle required for safety regulation is prevented from contacting the conductive member in the assembled state of the lamp. Therefore, the embodiment can avoid the safety hazards caused by unsafe operation.

The protrusion is arranged so that the insulating portion is sleeved on the protrusion, and the outer end of the insulating portion is flush with the outside of the pin after being assembled. The process of the assembly is more convenient, and the periphery is smoother after being assembled.

Moreover, by providing the cooperation of the insulating block and the L-shaped connector, the application would prevent the user's finger from touching the conductive member, and avoid the occurrence of electric spark between the two lamps that are not electrically connected and are very close to each other.

In addition, the present invention enables rotation of the gear under the action of the transmission path when the first connecting member is inserted into the interior of the second connecting member by the cooperation of the adjusting mechanism and the transmission path, the driving is driven. When the gear rotates, the block insulating rotates as well. As the insulating block rotates, one end of the L-shaped connector is moved to the open side of the rectangular frame, so that the L-shaped connector can be inserted into the inside part of the through hole to be electrically connected with the plug. When the connection is no longer required, the plate-shaped driving member is located in the inner groove of the rotating shaft. Therefore, when the rotating shaft rotates, the insulating block would not be driven to rotate, and the L-shaped connector is oriented toward the other end so as to avoid a phenomenon of electric sparks and improve the safety of the lamps.

### BRIEF DESCRIPTION OF THE DRAWINGS

FIG. 1 is a schematic view showing the structure of a lamp of the present invention.

FIG. 2 is a partial schematic view of a pin of the first embodiment of the lamp of the present invention.

FIG. 3 is a partial schematic view of the pin of the second embodiment of the lamp of the present invention.

FIG. 4 is a partial schematic view of the pin of the third embodiment of the lamp of the present invention.

FIG. 5 is a partial schematic view of the pin of the fourth embodiment of the lamp of the present invention.

FIG. 6 is a partial schematic view of the pin of the fifth embodiment of the lamp of the present invention.

FIG. 7 is a partial schematic view of the pin of the sixth embodiment of the lamp of the present invention.

FIG. 8 is a cross-sectional view showing the structure of the first connecting member in the seventh embodiment,

FIG. 9 is a cross-sectional view showing the second connecting member in the seventh embodiment;

FIG. 10 is a schematic structural view of the adjusting mechanism in the seventh embodiment;

FIG. 11 is a cross-sectional view showing the rotating shaft of the seventh embodiment;

FIG. 12 is a cross-sectional view showing the cylindrical structure of the seventh embodiment in a plan view;

FIG. 13 is a cross-sectional view showing the structure of the first connecting member in the eighth embodiment; and

FIG. 14 is a schematic view showing the connection structure of the conductive post, the L-shaped connector, and the pin in the eighth embodiment.

### REFERENCE NUMBERS

1 lamp body, 2 first connecting member, 3 second connecting member, 4 pin, 5 plug, 501 conductive post, 502 insulating head, 6 insulating sleeve, 7 rectangular frame, 8 insulating block, 9 adjusting mechanism, 901 rotating shaft, 902 gear, 903 lifting column, 904 T-shaped groove, 905 drive assembly, 9051 rod-shaped driving member, 9052 connecting rod, 9053 plate-shaped driving member, 906 elastic telescopic rod, 10 transmission path, 11 elastic piece 12 block, 13 elastic element, 14 stopper, 15 L-shaped connector, 16 cylindrical structure, 17 drive wheel, 18 driven wheel, 19 rubber block, 20 conductive rod; 21 hidden connecting member; 22 connector terminal; 23 insulating portion; 24 protrusion; 25 groove.

### DETAILED DESCRIPTION

The invention is further described below in conjunction with the drawings and specific embodiments, but the invention is not limited to the specific embodiments.

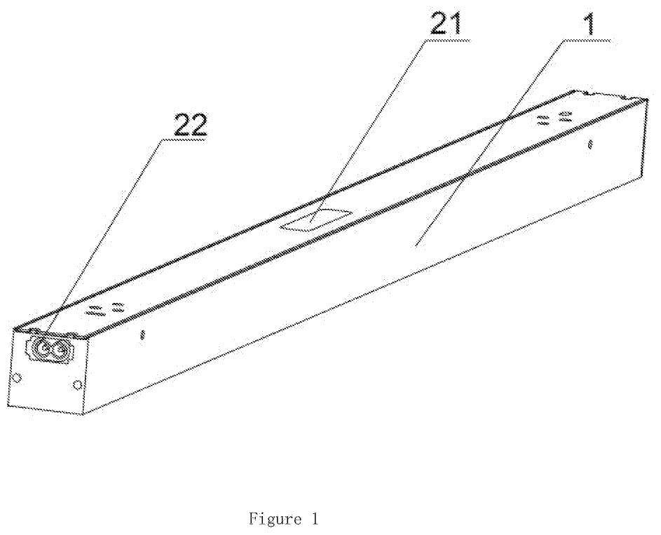

A lamp as shown in FIG. 1 comprises a lamp body 1. The lamp body 1 has a hidden connecting member 21 on its back. The lamp body 1 comprises connector terminals 22 on both sides thereof. The connector terminals 22 comprise a first connecting member 2 and a second connecting member 3. The first connecting member 2 comprises a pin 4, and the second connecting member 3 comprises a plug 5 for inserting the pin 4. The plug 5 and the pin 4 are electrically connected to the hidden connecting member 21 of the lamp body, and the pin 4 comprises an insulating portion 23. In the embodiment, the pin 4, also known as a PIN needle, is a conventional product in the field of electrical connection.

The first connecting member 2 is provided with two pins therein, and further comprises some pin sleeves for protecting the pins and, preventing the user from touching the pins. This is a conventional technique so it is not described herein in detail. A terminal sleeve is generally provided outside the first connecting member. When not in use, the terminal sleeve is always placed on the first connecting member. The hidden connecting, member 21 is disposed on the back of the lamp body. An opening is opened in the back of the lamp body, and a power connection wire is extended from the opening so that the power connection wire on the back is not seen after the lamp is installed.

The insulating portion 23 is made of an insulating material.

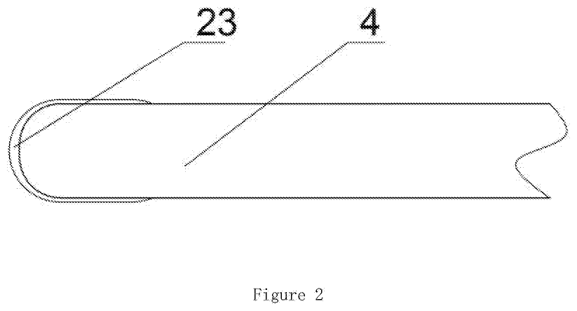

In the first embodiment, as shown in FIG. 2, the top of the pin 4 is arc-shaped, and then the top of the pin 4 is directly coated with an insulating material to form an insulating layer.

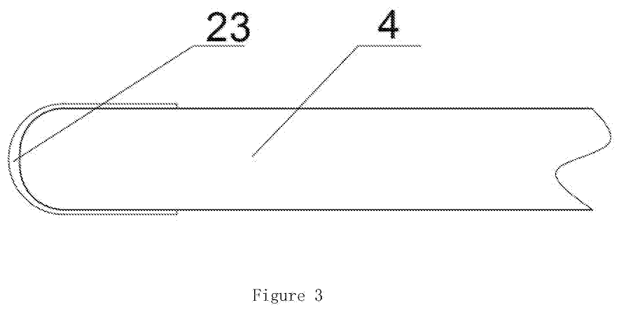

In the second embodiment, as shown in FIG. 3, the top of the pin 4 is arc-shaped, and then the insulating portion 23 is disposed as an insulating portion 23 matching with the shape of the top of the pin 4. The insulating portion 23 is sleeved on the top of the pin during usage.

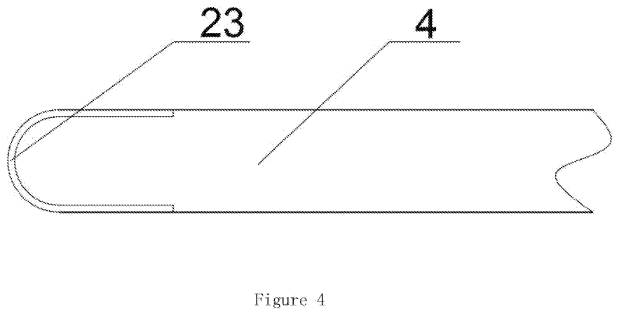

In the third embodiment, as shown in FIG. 4, the top of the pin 4 is arc-shaped, and the outer portion of the arc is provided with a circular step, and then the insulating portion 23 is arranged to match the shape of the top of the pin 4 and sleeved thereon. The insulating portion 23 on the circular step sleeves the insulating portion 23 on the top of the pin 4 during usage. The bottom portion of the insulating portion 23 abuts against the step. The outer end of the insulating portion 23 is flush with the outer end of the pin 4.

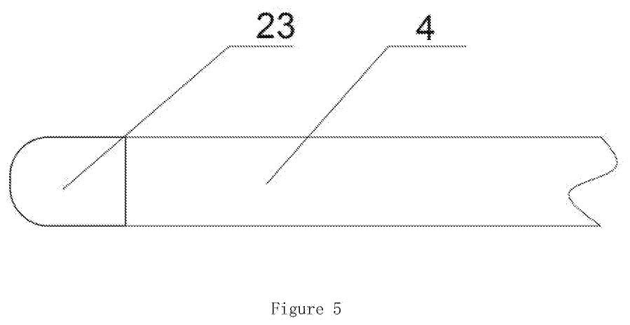

In the fourth embodiment, as shown in FIG. 5, the top of the pin 4 is flat, and then an arc-shaped insulating portion 23 is injection molded on the plane.

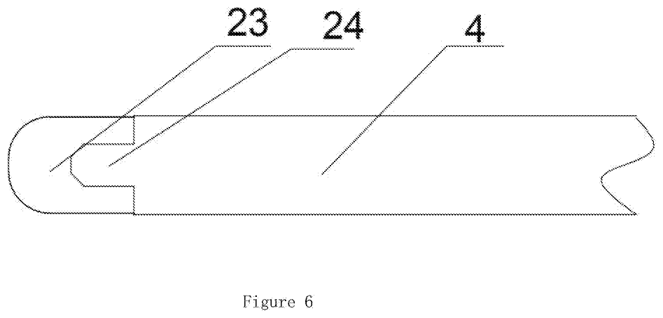

In the fifth embodiment, as shown in FIG. 6, a protrusion 24 is protruded from the top of the pin 4, and then an insulating portion 23 is injection molded on the protrusion 24. The outer end of the insulating portion 23 is flush with the outside of the pin 4 after injection molding.

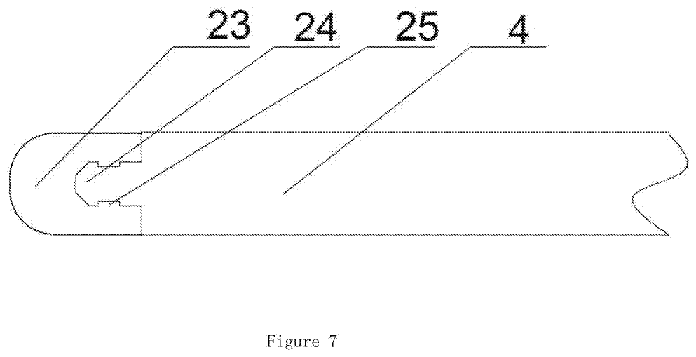

In the sixth embodiment, as shown in FIG. 7, a protrusion 24 is also protruded from the top of the pin 4, and a groove 25 is further provided on the circumference of the protrusion 24, and then an insulating portion 23 is injection molded on the protrusion 24. The outer end of the insulating portion 23 is flush with the outside of the pin 4 after the injection molding.

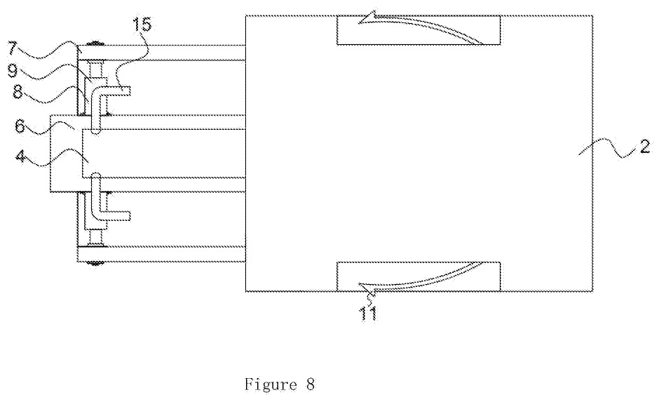

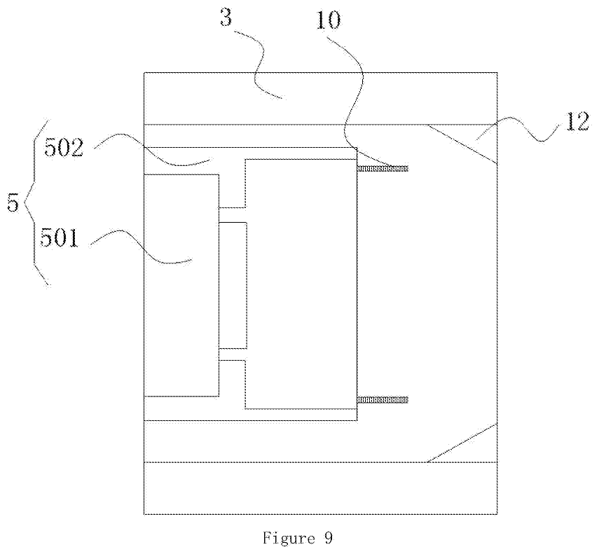

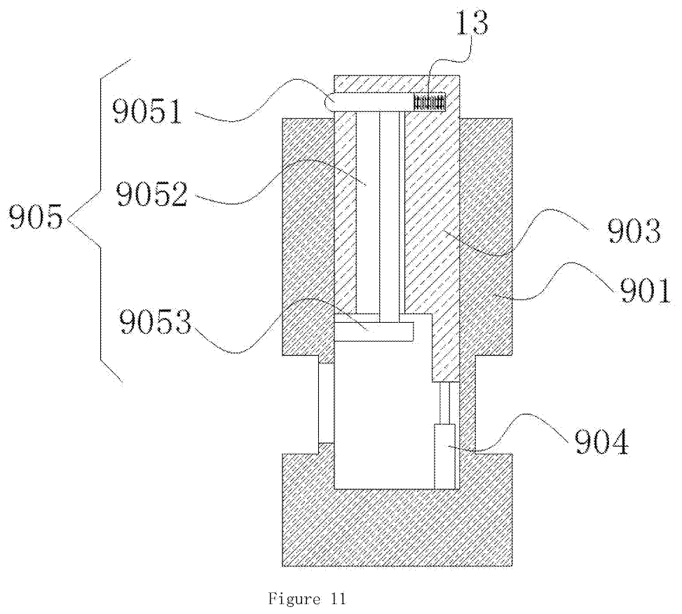

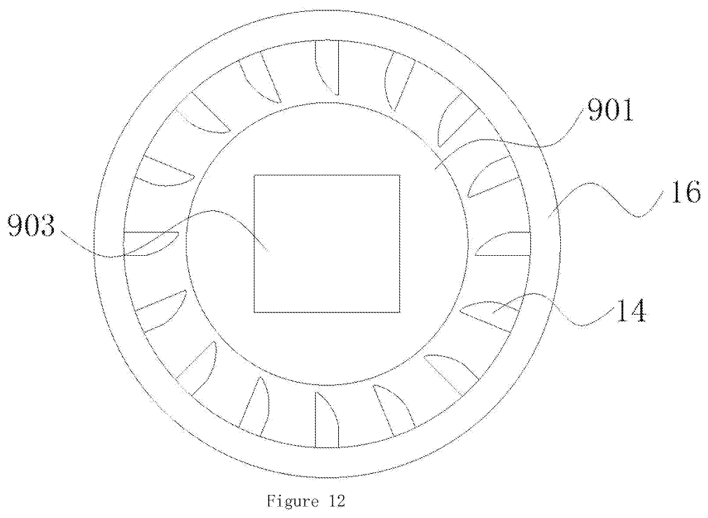

In the seventh embodiment, as shown in FIG. 8-12, an embodiment of the present invention provides a lamp, specifically including a lamp body 1 provided with a connector terminal 22 and a hidden connecting member 21. The connector terminal includes a first connecting member 2 and a second connecting member 3. A pin 4 is arranged within the inside part of the first connecting member 2. The second connecting member 3 comprises a plug 5 within for inserting the pin 4. The plug 5 and the pin 4 are both electrically connected to the connector of the lamp body 1.

The outer surface of the pin 4 is covered with an insulating sleeve 6. A rectangular frame 7 is arranged on one side of the first connecting member 2 and outside the insulating sleeve 6. A rotatable insulating block 8 is arranged on the insulating sleeve 6 and the rectangular frame 7. An L-shaped connector 15 is mounted on the insulating block 8. One end of the L-shaped connector 15 extends through the insulating block 8 to be in contact with the pin 4 and the insulating sleeve 6. The other end of the L-shaped connector 15 faces the first connecting member 2. The rectangular frame 7 further comprises an adjustment mechanism 9.

The plug 5 includes a conductive post 501 electrically connected to the connector of the lamp body 1 and an insulating head 502 wrapped outside the conductive post 501. The insulating head 502 has a groove on one side facing the second connecting member 3. A through hole adapted to the L-shaped connector 15 is opened at the bottom of the groove so that the conductive post 501 is connected to the outside, and the inside part of the groove further comprises a transmission path 10 adapted to an adjustment mechanism 9.

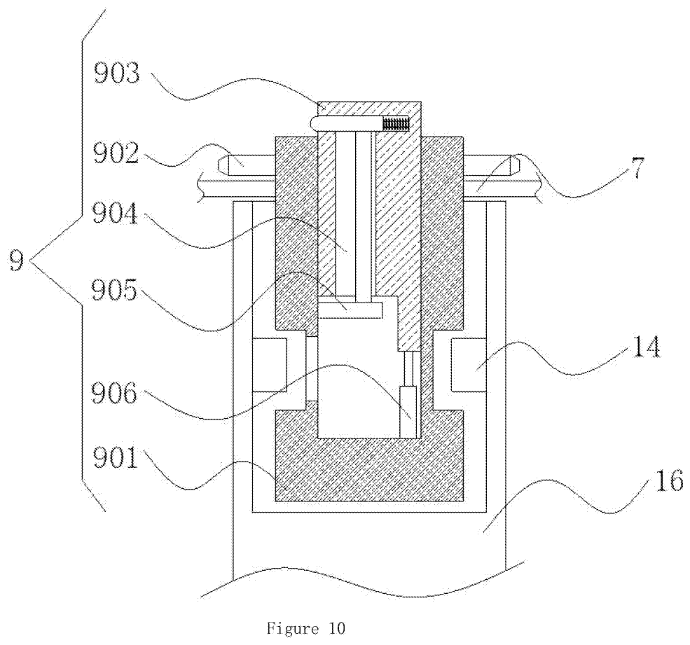

As shown in FIG. 10-12, the insulating block 8 is movably mounted on the outer side of the insulating sleeve 6 by bearings. A hollow cylindrical structure 16 is arranged on a side of the insulating block 8 away from the insulating sleeve 6. The adjusting mechanism 9 includes a rotating shaft 901 which is disposed through the bearing on the side wall of the rectangular frame 7. The rotating shaft 901 extends to the inside part of the cylindrical structure 16 and is not in contact with the inner wall of the cylindrical structure 16. A gear 902 is fixedly mounted on the rotating shaft 901, and the gear 902 is located outside of the rectangular frame 7. The top of the rotating shaft 901 is recessed. A lifting column 903 is provided in the recess at the top of the rotating shaft 901. The lifting column 903 is connected to the groove bottom of the recess of the rotating shaft 901 by an elastic telescopic rod 906. A T-shaped groove 904 is arranged on the lifting column 903. A movable driving assembly 905 is arranged in the inside part of the T-shaped groove 904, and a stopper 14 adapted to the driving assembly 905 is disposed on the inner wall of the cylindrical structure 16. The driving assembly 905 comprises a rod-shaped driving member 9051. A connecting rod 9052 is vertically mounted on the rod-shaped driving member 9051. The other end of the connecting rod 9052 extends below the lifting column 903 and is fixed with a plate-shaped driving member 9053, and the rotating shaft 901 has a through-hole to allow the plate-shaped driving member 9053 to pass through. The rod-shaped driving member 9051 is disposed in a transverse groove in the T-shaped groove 904. One end of the rod-shaped driving member 9051 extends through the lifting column 903 to the outside of the lifting column 903. An elastic member 13 is disposed between the other end of the rod-shaped driving member 9051 and the T-shaped groove 904.

In the present embodiment, the outer surface of the first connecting member 2 is provided with an elastic piece 11, and the inner wall of the second connecting member 3 is provided with a block 12 adapted to the elastic piece 11. The top and bottom of the first connecting member 2 are respectively provided with a groove. One end of the elastic piece 11 is fixed to the groove bottom, and the other end of the elastic piece 11 extends obliquely to the outside of the groove. The block 12 has a right-angled triangular prism shape, and the block 12 is inclined toward the open side of the second connecting member 3, and the other side of the block 12 is in a vertical state. The transmission path 10 is a rack that is adapted to the gear 902.

When two lamp bodies 1 need to be electrically connected, the lifting column 903 is pressed. As the lifting column 903 is lowered, the plate-shaped driving member 9053 is driven to descend. As soon as the plate type driving member 9053 is lowered to the position of the through slot, the plate-shaped driving member 9053 is pushed out by the elastic member 13, and after the plate type driving member 9053 is pushed out, it moves between the two stoppers 14. After the plate-shaped driving member 9053 moves to the two stoppers 14, the first connecting member 2 is inserted into the second connecting member 3. During the insertion, the gear 902 is rotated by the action of the rack. The rotating shaft 901 and the lifting column 903 are driven to rotate when, the gear 902 is rotated. As the lifting column 903 rotates, passing through the lifting column 903 is driven to rotate too. The cylindrical structure 16 is then driven by the plate-shaped driving member 9053 to rotate, and the insulating block 8 is driven to rotate by the cylindrical structure 16. When the insulating block 8 has been rotated by 180 degrees, one end of the L-shaped connector 15 is moved to the outside of the rectangular frame 7. During the insertion of the insulating head 502, the through hole penetrating into the insulating head 502 can be electrically connected to the conductive posts 501.

In a specific environment where the two lamp bodies 1 need to be connected physically but not electrically, the rod-shaped driving member 9051 is pressed to enable the plate-shaped driving member 9053 to enters the inside part of the rotating shaft 901 by the connecting rod 9052. The lifting column 903 is lifted up by the action of the elastic telescopic rod 906. After the lifting column 903 is lifted up, the first connecting member 2 is continuously inserted into the interior of the second connecting member 3. In the process of the insertion, the gear 902 and the rotating shaft 901 are driven to rotate under the action of the rack. But, the rotating block 901 does not rotate the insulating block 8 during the rotation. The L-shaped connector 15 is always kept within the rectangular frame 7 to effectively avoid the occurrence of electric sparks.

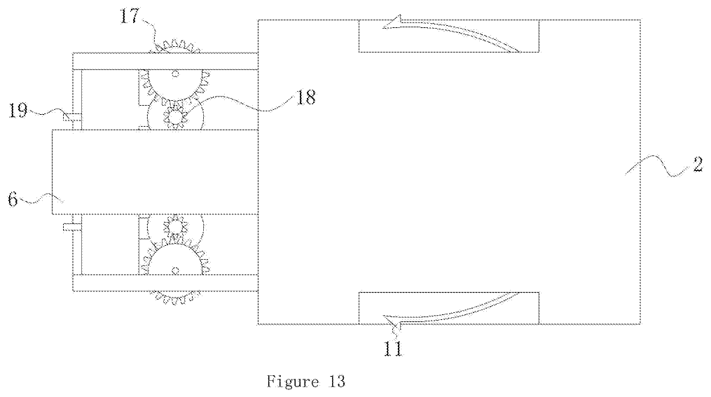

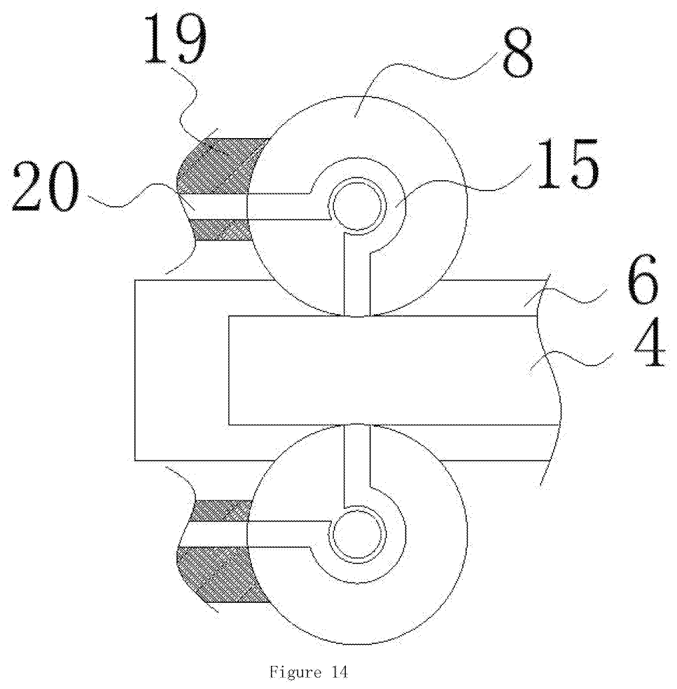

In the eighth embodiment 8 as shown in FIG. 13 and FIG. 14, a safe lamp has a lamp body 1 provided with a connector at the top. The lamp body 1 is symmetrically disposed with a first connecting member 2 and a second connecting member 3. A pin 4 is provided inside the first connecting member 2, and a plug 5 is provided inside the second connecting member 3 into which the pin 4 can be inserted. Both the plug 5 and the pin 4 are electrically connected to the connector of the lamp body 1.

The outer surface of the pin 4 is covered with an insulating sleeve 6. A rectangular frame 7 is arranged on one side of the first connecting member 2 and outside the insulating sleeve 6. A rotatable insulating block 8 is arranged on the insulating sleeve 6 and the rectangular frame 7. An L-shaped connector 15 is mounted on the insulating block 8. One end of the L-shaped connector 15 extends through the insulating block 8 to be in contact with the pin 4 and the insulating sleeve 6. The other end of the L-shaped connector 15 faces the first connecting member 2.

The plug 5 includes a conductive post 501 electrically connected to the connector of the lamp body 1 and an insulating head 502 wrapped outside the conductive post 501. The insulating head 502 has a groove on one side facing the second connecting member 3. A through hole adapted to the L-shaped connector 15 is opened at the bottom of the groove so that the conductive post 501 is connected to the outside, and the inside part of the groove further comprises a transmission path 10 adapted to an adjustment mechanism 9.

The insulating block 8 has a cylindrical shape. An outer surface of the insulating block 8 passes through the insulating sleeve 6 to connect to outer surface of the pin 4. A driven wheel 18 is fixedly mounted at one end of the insulating block 8. A driving wheel 17 rotatably engaged with the driven wheel 18 is movably mounted inside the rectangular frame 7. One end of the driving wheel 17 extends through the rectangular frame 7 to the outside of the rectangular frame 7. A rubber block 19 is fixed at the opening of the rectangular frame 7. A conductive rod 20 is disposed through the rubber block 19. One end of the conductive rod 20 is in contact with an outer surface of the insulating block 8, and the other end of the conductive rod 20 extends to the outside of the rectangular frame 7. The transmission path 10 is a rack that is adapted to the gear 902 or the driving wheel 17. In the present embodiment, a scale is provided on the outer surface of the driving wheel 17. Before inserting the pin 4 into the inside of the plug 5, the driving wheel 17 is rotated to move the scale on the driving wheel 17 to a designated position, so that the pin 4 is inserted into the inside of the plug 5. The driving wheel 17 rotates the driven wheel 18 which in turn drives the insulating block 8 to rotate. When the plug 4 is fully inserted into the plug 5, one end of the conductive rod 20 penetrates through the through hole and becomes in contact with the conductive post 501. One end of the L-shaped connector 15 embedded in one end of the insulating block 8 becomes in contact with one end of the conductive rod 20 during the rotation of the insulating block 8. The other end of the L-shaped connection the head 15 becomes in contact with the outer surface of the pin 4 to connect the pin 4 to the plug 5 and supply power thereto. Moreover, if the scale is not adjusted to a specified position in the initial state, the driving wheel 17 drives the driving wheel 18 to rotate during the insertion of the first connecting member 2 into the second connecting member 3. After the conductive rod 20 is in contact with the conductive post 501, the two ends of the L-shaped connector 15 are no more in contact with the conductive post 20 and the pin 4, respectively. Insulation is thereby achieved and at the same time the electric sparks are avoided due to the presence of the insulating block.

It should be noted that the above embodiments are only for explaining the technical solutions of the present invention, and are not intended to be limiting. Although the present invention has been described in detail with reference to the foregoing embodiments, those skilled in the art will understand that the technical solutions described in the foregoing embodiments can be modified, or some of the technical features can be replaced, and the modifications and substitutions do not depart from the spirit and scope of the technical solutions of the embodiments of the present invention.

We claim:

1. A lamp comprising a lamp body (1), wherein the lamp body (1) has a hidden connecting member (21) on its back, the lamp body (1) comprises connector terminals (22) on both sides thereof, the connector terminals (22) comprise a first connecting member (2) and a second connecting member (3), the first connecting member (2) comprises a pin (4), and the second connecting member (3) comprises a plug (5) for inserting the pin (4), the plug (5) and the pin (4) are electrically connected to the hidden connecting member (21) of the lamp body, and the pin (4) comprises an insulating portion (23).

2. The lamp according to claim 1, wherein the top of the pin (4) comprises a protrusion (24), the protrusion (24) is integrally formed with the pin (4), the insulating portion (23) is wrapped around the protrusion (24), a groove (25) is provided on the circumference of the protrusion (24), and the outer end of the insulating portion (23) is in alignment with the outer portion of the pin (4).

3. The lamp according to claim 1, wherein the outer surface of the pin (4) is covered with an insulating sleeve (6), a rectangular frame (7) is arranged on one side of the first connecting member (2) and outside the insulating sleeve (6), a rotatable insulating block (8) is arranged on the insulating sleeve (6) and the rectangular frame (7), an L-shaped connector (15) is mounted on the insulating block (8), one end of the L-shaped connector (15) extends through the insulating block (8) to be in contact with the pin (4) and the insulating sleeve (6), the other end of the L-shaped connector (15) faces the first connecting member (2), the plug (5) includes a conductive post (501) electrically connected to the connector of the lamp body (1) and an insulating head (502) wrapped outside the conductive post (501), the insulating head (502) has a groove on one side facing the second connecting member (3), a through hole adapted to the L-shaped connector (15) is opened at the bottom of the groove so that the conductive post (501) is connected to the outside, and the inside part of the groove further comprises a transmission path (10) adapted to an adjustment mechanism (9).

4. The lamp according to claim 3, wherein the outer surface of the first connecting member (2) has an elastic piece (11), and the inner wall of the second connecting member (3) has a block (12) connected to the elastic piece (11).

5. The lamp according to claim 4, wherein the top and bottom of the first connecting member (2) respectively comprises a groove, one end of the elastic piece (11) is fixed at the bottom of the groove, the other end of the elastic piece (11) extends obliquely to the outside of the groove, the block (12) has a right-angled triangular prism shape, the side of block (12) close to the opening of the second connecting member (3) is inclined, and the other side of the block (12) is in a vertical state.

6. The lamp according to claim 3, wherein the insulating block (8) is movably mounted on the outer side of the insulating, sleeve (6) by bearings, a hollow cylindrical structure (16) is arranged on a side of the insulating block (8) away from the insulating sleeve (6), the rectangular frame (7) comprises an adjusting mechanism (9), the adjusting mechanism (9) includes a rotating shaft (901) which is disposed through the bearing on the side wall of the rectangular frame (7), the rotating shaft (901) extends to the inside part of the cylindrical structure (16) and is not in contact with the inner wall of the cylindrical structure (16), a gear (902) is fixedly mounted on the rotating shaft (901), and the gear (902) is located outside of the rectangular frame (7).

7. The lamp according to claim 6, wherein the top of the rotating shaft (901) is recessed, a lifting column (903) is provided in the recess at the top of the rotating shaft (901), the lifting column (903) is connected to the groove bottom of the recess of the rotating shaft (901) by an elastic telescopic rod (906), a T-shaped groove (904) is arranged on the lifting column (903), a movable driving assembly (905) is arranged in the inside part of the T-shaped groove (904), and a stopper (14) adapted to the driving assembly (905) is disposed on the inner wall of the cylindrical structure (16).

8. The lamp according to claim 7, wherein the driving assembly (905) comprises a rod-shaped driving member (9051), a connecting rod (9052) is vertically mounted on the rod-shaped driving member (9051), the other end of the connecting rod (9052) extends below the lifting column (903) and is fixed with a plate-shaped driving member (9053), and the rotating shaft (901) has a through-hole to allow the plate-shaped driving member (9053) to pass through.

9. The lamp according to claim 8, wherein the rod-shaped driving member (9051) is disposed in a transverse groove in the T-shaped groove (904), one end of the rod-shaped driving member (9051) extends through the lifting column (903) to the outside of the lifting column (903), an elastic member (13) is disposed between the other end of the rod-shaped driving member (9051) and the T-shaped groove (904).

10. The lamp according to claim 3, wherein the insulating block (8) has a cylindrical shape, an outer surface of the insulating block (8) passes through the insulating sleeve (6) to connect to outer surface of the pin (4), a driven wheel (18) is fixedly mounted at one end of the insulating block (8), a driving wheel (17) rotatably engaged with the driven wheel (18) is movably mounted inside the rectangular frame (7), one end of the driving wheel (17) extends through the rectangular frame (7) to the outside of the rectangular frame (7), a rubber block (19) is fixed at the opening of the rectangular frame (7), a conductive rod (20) is disposed through the rubber block (19), one end of the conductive rod (20) is in contact with an outer surface of the insulating block (8), and the other end of the conductive rod (20) extends to the outside of the rectangular frame (7).
